(19) United States
(12) Patent Application Publication
(10) Pub. No.: US 2025/0246187 A1
(43) Pub. Date: Jul. 31, 2025

(54) SYSTEMS AND METHODS FOR DISFLUENT SPEECH TRANSCRIPTION AND DETECTION

(71) Applicant: The Regents of The University of California, Oakland, CA (US)

(72) Inventors: Gopala Anumanchipalli, San Ramon, CA (US); Jiachen Lian, Emeryville, CA (US)

(21) Appl. No.: 19/043,273

(22) Filed: Jan. 31, 2025

Related U.S. Application Data
(60) Provisional application No. 63/627,629, filed on Jan. 31, 2024.

(51) Int. Cl. G10L 15/187; G10L 15/02

(52) U.S. Cl. CPC G10L 15/187; G10L 15/02; G10L 2015/025

(57) ABSTRACT

A method for processing audio inputs to detect and transcribe disfluencies includes: receiving an audio input comprising spoken language; generating a phonetic transcription of the audio input by applying a recursive forced alignment process that produces a two-dimensional alignment without reliance on a monotonic alignment constraint; identifying disfluencies within the audio input by comparing a pre-determined number of disfluency templates to the two-dimensional alignment; providing a timestamp for each detected disfluency; and outputting a transcription of the audio input that includes indications of the detected disfluencies and their respective timestamps.

### CROSS-REFERENCE TO RELATED APPLICATION

The present application claims priority to U.S. Provisional Application No. 63/627,629, entitled “SYSTEMS AND METHODS FOR DISFLUENT SPEECH TRANSCRIPTION AND DETECTION”, and filed on Jan. 31, 2024. The entire contents of the above-listed application are hereby incorporated by reference for all purposes.

### GOVERNMENT SUPPORT

This invention was made with government support under Grant Number NS050915 awarded by the National Institutes of Health. The government has certain rights in the invention.

### BACKGROUND AND SUMMARY

Spoken language disfluency modeling is the core technology in speech therapy and language learning. An estimated 17.9 million adults and 1.4 percent of children in the U.S. suffer from chronic communication and speech disorders. Currently, hospitals have to invest substantial resources in hiring speech and language pathologists (SLPs) to manually analyze and provide feedback. More importantly, the cost is not affordable for low-income families. Kids' speech disorders also have a significant connection to the language learning market. According to a report, the English language learning market will reach an estimated value of 54.8 billion by 2025. Unfortunately, there is not an artificial intelligence (AI) tool that can effectively automate this problem.

In current research community, there is not a unified definition for disfluent speech. As such, the definition of disfluent speech is hereby solidified as any form of speech characterized by abnormal patterns such as repetition, replacement, and irregular pauses. Within the domain of disfluent speech modeling, research efforts are conducted both on the speech side and the language side. Whenever disfluent speech transcription is given (such as human transcription in FIG. 1), the problem can be tackled by large language models (LLMs). However, such transcription is not available and current best automatic speech recognition (ASR) systems tend to recognize them as perfect speech. Thus, it would seem that the bottleneck lies in the speech side rather than in language.

Unfortunately, there is also no established definition for the problem of speech disfluency modeling. Speech disfluency modeling is hereby defined to detect all types of disfluencies at both the word and phoneme levels while also providing a time-stamp for each type of disfluency. In other words, disfluency modeling should be hierarchical and time-accurate. Previous research has mainly focused on a small aspect of this problem.

Researchers started by focusing on spotting stuttering using end-to-end methods. They manually tagged each utterance and developed the classification model at the utterance level. Later on, things got detailed with frame-level stutter detection. However, end-to-end methods have their limitations. First, stuttering is just one aspect of disfluency. Current end-to-end models struggle to handle other forms of disfluency effectively. Second, manually labeling data for these methods is a lot of work and not practical for larger-scale projects. Lastly, disfluency modeling depends on the specific text being spoken, a factor that has been overlooked in previous research.

It is typically intuitive to consider speech transcription that offers disfluency-specific representations. For a long time, the mainstream of researchers in speech transcription has been focused on word-level ASR, which has been further scaled. However, the most advanced word transcription models currently available can only transcribe certain obvious word-level disfluency patterns, such as word repetition or replacement. However, the majority of disfluencies occur at the phoneme-level or subword-level, making them challenging for any ASR system to explicitly detect. A neural forced aligner that incorporates time accuracy and sensitivity to silence was introduced. This aligner employs a weighted finite-state transducer (WFST) to capture disfluency patterns like repetition. However, it fails on openset disfluency modeling.

The Unconstrained Disfluency Model (UDM) was devised to address the aforementioned challenges comprehensively. UDM seamlessly integrates both transcription and detection modules within a unified framework. Within the UDM framework, non-monotonic alignments are acquired through dynamic alignment search, forming the foundation for subsequent template matching algorithms aimed at detecting various disfluency types. Specifically, distinct templates are tailored for each disfluency category, encompassing replacements, insertions, deletions, blocks, and repetitions. Additionally, VCTK++ dataset is introduced to further enhance model performance. The capabilities of UDM can be extended by incorporating a monotonicity constraint. While non-monotonic alignment is essential for effective disfluency modeling, certain experiments demonstrate that the integration of a simple Connectionist Temporal Classification (CTC) module alongside a phoneme classifier can enhance non-monotonicity. Introduced here is the Unconstrained Recursive Forced Aligner (URFA), which employs an iterative process to generate both phoneme alignments (1D) and 2D alignments with weak text supervision. This recursive modeling significantly enhances detection robustness. The disclosed method, termed Hierarchical Unconstrained Disfluency Modeling (H-UDM), attains state-of-the-art performance in real aphasia speech disfluency detection.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Implementations of the disclosed technology are directed to a hierarchical unconstrained dysfluency modeling (H-UDM). H-UDM introduces CTC monotonicity, and the incorporation of recursive modeling significantly enhances both transcription and disfluency detection results by a substantial margin.

FIG. 1 illustrates an example 100 of Hierarchical Unconstrained Disfluency Modeling (H-UDM) that consists of Transcription module 102 and Detection module 104. Both word-level and phoneme-level disfluencies are detected and localized. This is an example of aphasia speech. The reference text is “You wish to know all about my grandfather” while the real/human transcription differs significantly from the reference. Whisper recognizes it as perfect speech, while H-UDM is able to capture most of the disfluency patterns.

FIG. 2 illustrates an example 200 of Unconstrained Recursive Forced Aligner (URFA) that consists of three basic modules: UFA, 2D alignment Search, and Smoothed Re-segmentation. In the first iteration (Zero-order), the entire utterance is taken and 2D alignment is generated. Starting at 2nd iteration (1st-order), the disfluent speech is segmented at word level and each segment is processed separately and then combined to generate the final 2D alignment for detection.

FIG. 3 illustrates an example 300 of two-dimensional (2D)-Alignment Modeling.

FIG. 4 illustrates an example 400 of Scaling law for ASR under various conditions: (i) Perfect ASR (p-ASR); (ii) Imperfect ASR (i-ASR); (iii) Overall ASR (o-ASR).

Human Data Annotation: For all disordered speech (aphaisa and dylexia), users can work together to manually label the disfluencies: types of disfluency and its time stamp at both word and phoneme level. As the disfluency patterns are straightforward to observe, each utterance is labelled by only one person.

FIGS. 5-9 illustrate examples of Word Segmentation in which GT denotes ground truth. Some samples might have multiple ground truths denoted as GT1, GT2, etc.

FIG. 5 illustrates an example 500 of Segmentation—(Dyslexia Sample: Giving those who observe him.)

FIG. 6 illustrates an example 600 of Segmentation—(Dyslexia Sample: But he always answered banana oil.)

FIG. 7 illustrates an example 700 of Segmentation—(Dyslexia Sample: We have often urged him.)

FIG. 8 illustrates an example 800 of Segmentation—(Aphasia Sample: Usually several buttons missing.)

FIG. 9 illustrates an example 900 of Segmentation—(My stutter sample: Please call stella.)

### DETAILED DESCRIPTION

Implementations of the disclosed technology are generally directed to systems and methods for processing audio inputs to detect and transcribe disfluencies.

### Transcription Module

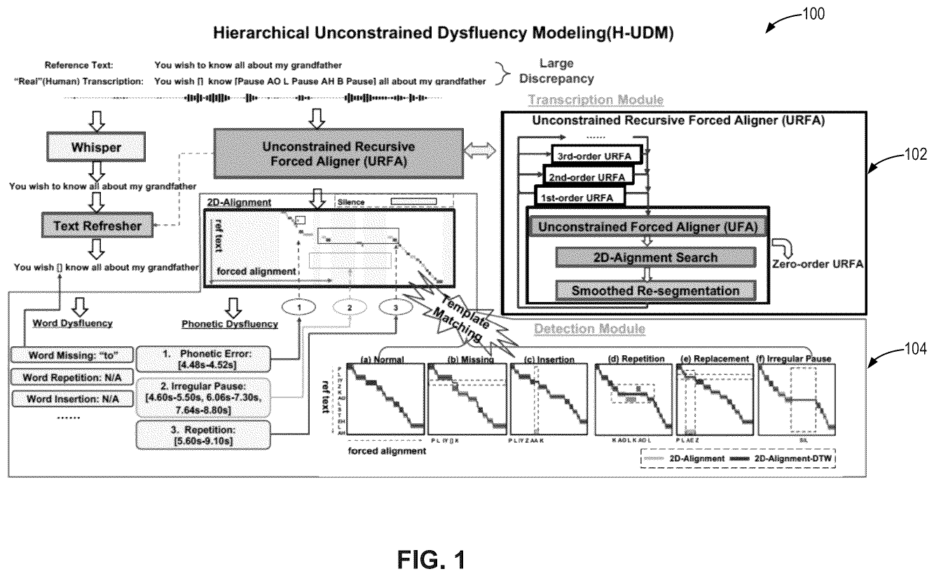

The disclosed transcription module consists of two core parts: (1) Unconstrained Recursive Forced Aligner (URFA), which generates phonetic transcriptions (2D-Alignment), and (2) Text Refresher which takes both Whisper output and 2D-Alignment to generate word transcription, as illustrated by FIG. 1.

### Unconstrained Recursive Forced Aligner (URFA)

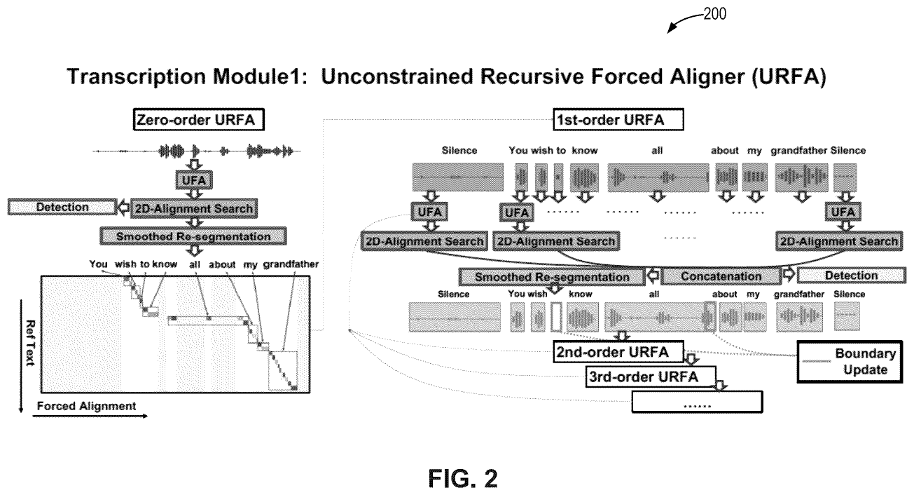

The bottleneck for disfluent speech alignment is that the real text transcription is unknown, which is significantly different from the reference text, as illustrated by FIG. 1. However, disfluency detection relies on the reference text. Traditional speech-text aligners assume that the reference text is the same as the real text transcription, and thus they only work for normal fluent speech. Let's look at a simple example. If the reference text is “K AE Y (Cat)” and the actual speech (real text transcription) is “K AE K AE T (Ca-Cat),” then the alignment from traditional aligners will all be “K AE T” as monotonicity is enforced, which is not accurate. For disfluent speech detection, deriving non-monotonic speech-text alignment is required, and this is achieved through the Unconstrained Forced Aligner (UFA). As disfluency detection depends on the reference text, we also introduce 2D-Alignment to align the non-monotonic phoneme alignment with the reference text. Additionally, we deploy our alignment methods recursively, re-segmenting the utterance based on the 2D-Alignment to refine 2D-Alignment itself. The entire paradigm is illustrated in FIG. 2. Each sub-module is detailed in the following.

### Unconstrained Force Aligner (UFA)

The UFA operates by predicting alignments with the guidance of weak text supervision. Initially, the speech segment undergoes encoding by the WavLM encoder, which generates latent representations. Subsequently, a conformer module is employed to predict both alignment and boundary information. The alignment and boundary targets used in UFA are derived from the Montreal Forced Aligner (MFA). During the inference stage, there is no requirement for text input, rendering the alignment process truly “unconstrained.” To perform phoneme classification, UFA applies two linear layers. For the phoneme classifier, UFA optimizes the softmax cross-entropy objective, while logistic regression is utilized for boundary prediction. Notably, experimentation has demonstrated that introducing an additional Connectionist Temporal Classification (CTC) constraint (monotonicity) can enhance the robustness of the non-monotonic alignment. It should be noted that CTC is solely involved in the training stage.

### Dynamic Alignment Search

In the context of disfluency modeling, alignment must be non-monotonic. This stands in stark contrast to traditional forced aligners, which typically enforce monotonic alignment based on supervised signals such as text. However, herein, text supervision is complicated by the substantial divergence between the real transcription and the reference text. Consequently, the reference text becomes an unreliable source for alignment. The process of decoding the alignment sequence from the emission matrix can be accomplished through various methods. In the disclosed approach, the boundary-aware Viterbi algorithm is applied for decoding. It should be noted that the modified Viterbi algorithm introduces a computational complexity of O(tN²), where N represents the vocabulary size and t denotes the number of time steps. Given that, in practice, t is typically much larger than N, this computational complexity remains within acceptable bounds. The inclusion of boundary information proves invaluable in handling the ambiguity introduced, particularly by silence. In addition, a phoneme autoregressive language model can be trained using the VCTK corpus. Alternate approaches can include utilizing the bi-gram model.

### Two-Dimensional (2D)-Alignment Modeling

The underlying idea revolves around a fundamental question: how accurately does the forced alignment correspond to the reference text? The 2D-Alignment was devised as a metric to assess this alignment. Specifically, the 2D-Alignment represents the temporal alignment between the actual spoken text by the speaker (ground truth text) and the disfluent alignment generated by the dynamic alignment search module. In a prior case, this 2D alignment was computed by performing clement-wise multiplication between the reference phoneme embeddings and the forced alignment phoneme embeddings. It should be noted that this 2D-Alignment is inherently non-monotonic. However, this approach has significant limitations. Through real speech testing, in the presence of noise, the noise can become erroneously aligned with parts of the reference text, which is not desirable. Additionally, using phonemes as the primary units for disfluency modeling may not be optimal. For example, there may be minimal phonetic distinctions between certain phonemes, such as ‘AH’ and ‘AO,’ in terms of verbal pronunciation. Nonetheless, in both non-monotonic alignment and 2D-Alignment, they are treated as distinct phonemes and are considered uncorrelated. Despite these limitations, the ground truth 2D-Alignment can still be retained for template matching algorithms. This ground truth 2D-Alignment, referred to herein as 2D-Alignment-DTW, is always monotonic in nature.

### Smoothed Re-Segmentation and Recursive Alignment

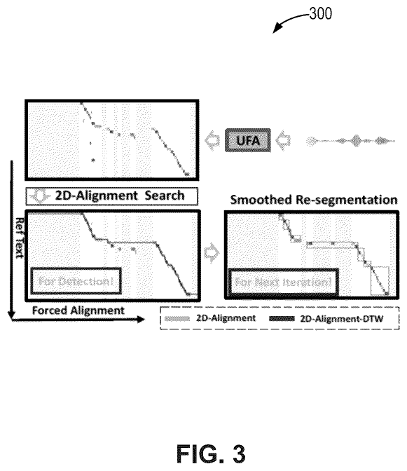

The generation of non-monotonic alignment inherently introduces variances that can lead to misdetection. To address this issue, the disfluent speech can be segmented by word boundaries and alignment for each segment can be generated, potentially mitigating the problem. For instance, consider the case illustrated by FIGS. 1 and 2, where the sequence [AO L Pause AH B] actually corresponds to the word “all.” Another source of variance arises when individuals utter sequences like “AH, AO, AY,” which may indicate the repetition of the phoneme “AH.” However, our 2D alignment treats them as distinct phonemes, failing to detect the repetition, which poses a significant challenge. To tackle this issue, a phoneme smoothing technique can be introduced. Specifically, at each time step, the cosine similarity of phoneme embeddings can be calculated for both 2D-Alignment and 2D-Alignment-DTW. If the similarity falls within a predefined threshold, the 2D-Alignment can be merged into 2D-Alignment-DTW, as demonstrated in the final figure of FIG. 3. This process yields a monotonic 2D alignment, allowing for the identifying of word boundaries by simply locating each word along the “ref text” axis. These segmented results serve as input for 1st-order Unconstrained Forced Aligner (URFA), as illustrated by FIG. 2.

In 1st-order URFA, a 2D-Alignment can be computed for each segment and they can be subsequently concatenated. This iterative approach can be extended to 2nd-order URFA, 3rd-order URFA, and beyond. It should be noted that the smoothed monotonic 2D-Alignment is exclusively used for segmentation purposes, while the original non-monotonic 2D-Alignment remains in use for detection. This recursive aligner yields improved word boundary detection, as exemplified in FIG. 2, where the boundaries obtained in 1st-order alignment outperform those of zero-order alignment in capturing disfluencies.

### ASR Scalability

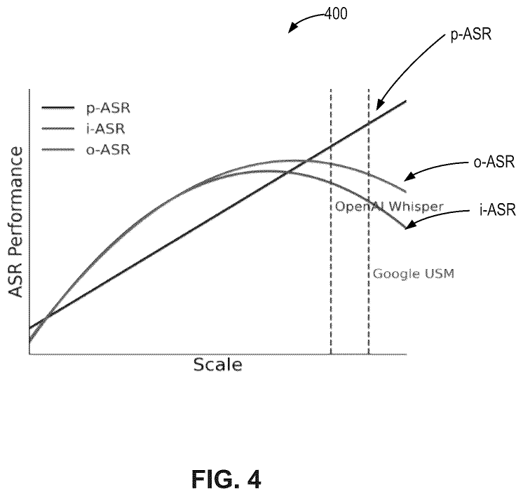

Recent advances in spoken language processing indicate the effectiveness of scaling laws concerning data and model scale. The limit of scaling has not been reached yet. However, the scaling law for ASR is most effective for normal or perfect speech (p-ASR in FIG. 4). In real-life settings, things are very different for imperfect speech, such as disfluent speech. Due to the power of language modeling in ASR systems, most imperfect speech is treated as perfect speech, leading to a significant performance drop for imperfect ASR (i-ASR in FIG. 4). The overall ASR (o-ASR in FIG. 4), which includes both parts, should also follow the same trend. A text refresher can be used to introduce imperfections for disfluent speech in an attempt to avoid the aforementioned problems. The solutions are intuitive. Of all imperfections (disfluencies) at the word level, insertions and deletions are the hardest to detect. However, this can be easily observed on the 2D-Alignment introduced in the previous section. In the 2D-Alignment, we also have 2D-Alignment-DTW as a reference. If the 2D-Alignment does not align with any reference words, then it is likely an insertion, and if the word from the ASR system is redundant in comparison to the 2D-Alignment phoneme sequence, it is likely a deletion. It should be noted that URFA also generates word transcriptions. However, it exhibits inferior performance in word-level disfluency detection compared to the “text refresher.” Therefore, URFA can be employed exclusively for phonetic-level disfluency detection.

### Transcription Module Evaluation

### Duration-Aware Phonetic Transcription

A current phonetic transcription evaluation can be followed. Here, more insights can be provided for each evaluation metric. First, the transcribed phonemes must be intelligible at the segment level, which is evaluated by the phoneme error rate (PER). Second, the transcribed phonemes must be intelligible at the frame-level, which is evaluated by frame-level Micro F1 Score and Macro F1 Score. Third, the transcribed phonemes must be intelligible at both the segment and frame levels, which is evaluated by the combination of the above metrics. This is also known as dPER. In more detail, dPER is the duration-aware extension of PER. For each operation to be counted, the duration for it is considered.

### Duration-Aware Imperfect Word Transcription

Disfluent speech is imperfect speech. Traditional ASR systems are typically evaluated by how well the hypothesis matches the ground truth text. In disfluent settings, ASR systems are evaluated based on how well the hypothesis matches the imperfect targets. A current technique to adopt the imperfect word error rate (i-WER) is followed where the disfluent (imperfect) targets are labeled by humans. Segment-level imperfect ASR evaluation, similar to dPER vs PER, can be employed where duration is also considered. In detail, the Intersection over Union (IoU) can be calculated between predicted time boundaries from URFA and the ground truth boundaries from human annotations. If the IoU is greater than 0.5, the disfluency is identified as detected. The F1 score can be reported for this matching evaluation, referred to as the Matching Score (MS).

### Detection Module

A separate design for the detection and transcription modules can be adopted such that an end-to-end modeling approach for the detection system is not reliable. The transcription module provides disfluency-aware representations to optimize the detection module. Here, design learning-based methods can still be used to predict the detection results; however there are no human labels for disfluencies. Instead, a smart label-free system can be used that simply employs the template matching algorithm for each type of disfluency. Template matching is efficient and reliable, eliminating the need for human annotation. Disfluency templates can be used for both word and phoneme levels. These disfluencies include Phonetic Errors (Missing, Deletion, Replacement), Repetition, and Irregular Pause. The disclosed methods also cover word-level disfluencies, including Missing, Insertion, Replacement, and Repetition.

### Phonetic-Level Disfluency Detection

A current approach for designing disfluency templates can be followed. Instead of directly handling the alignment from dynamic alignment search, alignment data from the URFA module can be considered. The processes can be repeated. In FIG. 1-Template, when examining alignments in normal speech, perfect alignment between the two representations can be observed. However, closer examination reveals distinctive patterns within these alignments. If a significant drop in alignment-2D-DTW is noticed without any overlap in the corresponding row, this signals the presence of a missing phoneme, as depicted in FIG. 1-Template-(b). When a row in alignment-2D-DTW intersects with multiple columns in alignment-2D and contains repeated phonemes, it indicates a repetition, as illustrated in FIG. 1-template-(d). Conversely, if a row in alignment-2D-DTW aligns with alignment-2D and simultaneously matches the surrounding column in alignment-2D, this signifies an insertion, as exemplified in FIG. 1-template (c). When a row in alignment-2D-DTW fails to overlap with any horizontal regions in alignment-2D but does overlap with a single vertical block in alignment-2D, it is categorized as a replacement, as demonstrated in FIG. 1-template (e). Lastly, any pauses occurring within a complete sentence are recognized as irregular pauses, as shown in FIG. 1-template (f).

### Word-Level Disfluency Detection

The same processes can be followed for detecting word-level disfluencies, e.g., as done for phoneme-level disfluencies. Neither duration nor silence were taken into consideration. It should be noted that the best results were selected from either URFA or the text refresher. An evaluation framework was adhered to for assessing hierarchical disfluency. To provide a more detailed evaluation, F1 scores were utilized and matching scores that consider temporal labels.

### Experiments

### Datasets and Pre-Processing

VCTK was utilized for training the UFA module.

VCTK⁺⁺ is a disfluency-aware simulated speech based on VCTK. Three types of disfluencies are introduced: repetitions, prolongations, and blocks. For repetitions and prolongations, phonemes are randomly selected and prolonged or repeated for a random duration. These operations are performed in the temporal domain (waveform). VCTK++ is utilized for training the UFA.

Buckeye includes substantial segments of disfluent speech that have been meticulously annotated with precise time markings. Buckeye serves as a resource for both training the UFA module and conducting Phonetic Transcription Evaluation.

### Phonetic Transcription Experiments

In a current case, phonetic experiments were conducted on several tasks. First, two baselines were attempted. One is named WavLM-CTC-VAD, where VAD introduces silence into the WavLM-CTC alignment. The other is WavLM-CTC-MFA, where phoneme labels from WavLM-CTC are set as MFA targets. Results indicate that UFA outperforms the baselines under various settings (Buckeye test set and VCTK++ test set). The role of monotonicity that was introduced can be explored. Specifically, the CTC constraint can be applied to latent embeddings in the UFA module. An additional phoneme recognition module can be applied to introduce such monotonicity. The intuition behind introducing this monotonicity is that the learned phonetic alignment still jumps up and down for disfluent speech and is unstable. In this module, only UFA is trained without any recursive learning, which will be introduced later on. It should be noted that UFA remains constant throughout the recursive process. Therefore, the evaluation focuses solely on the alignment produced by UFA rather than that of URFA, as the latter is directly proportional to the former. Phonetic transcription results are shown in the Table 1 below.

TABLE 1
Phonetic Transcription Evaluation

| | | | [symbol] | [symbol] | [symbol] | [symbol] | [symbol] | [symbol] | [symbol] | [symbol] |
|---|---|---|---|---|---|---|---|---|---|---|
| [symbol] | [symbol] | [symbol] | [symbol] | | | | [symbol] | | | |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] |

[symbol]

indicates data missing or illegible when filed

### Imperfect Word Transcription Experiments

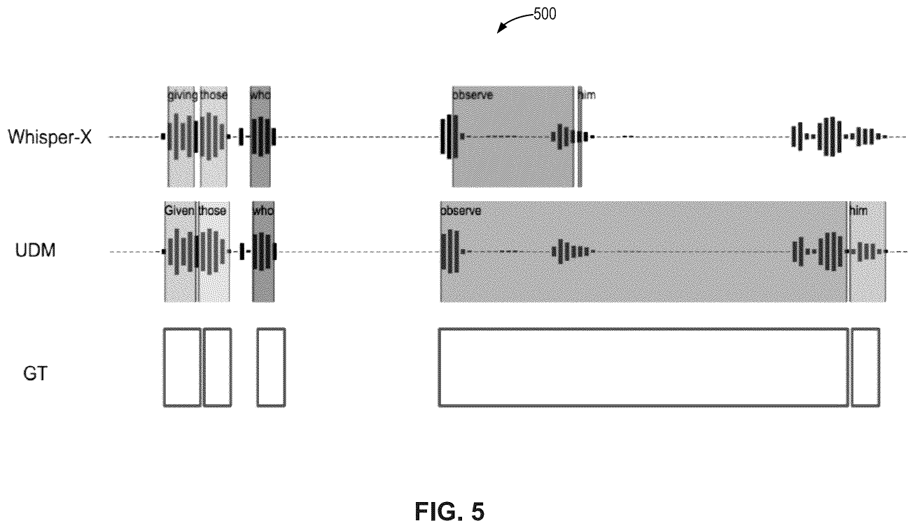

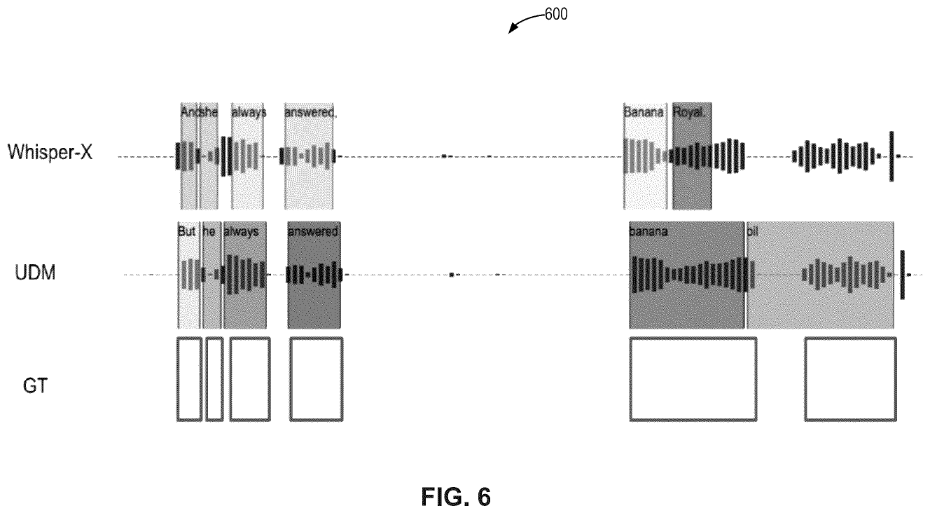

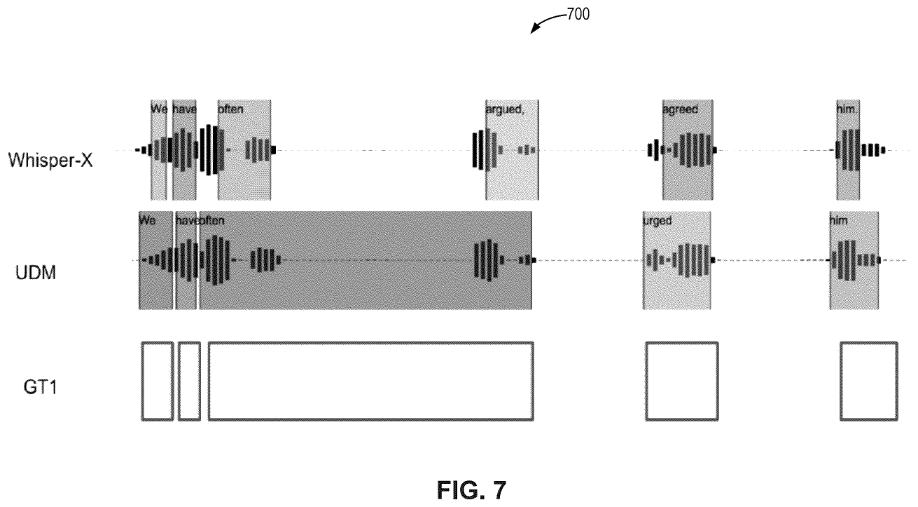

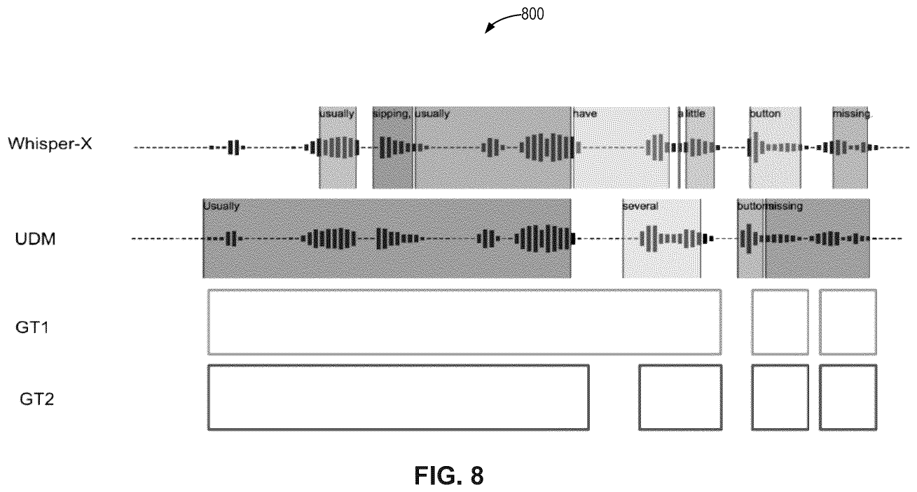

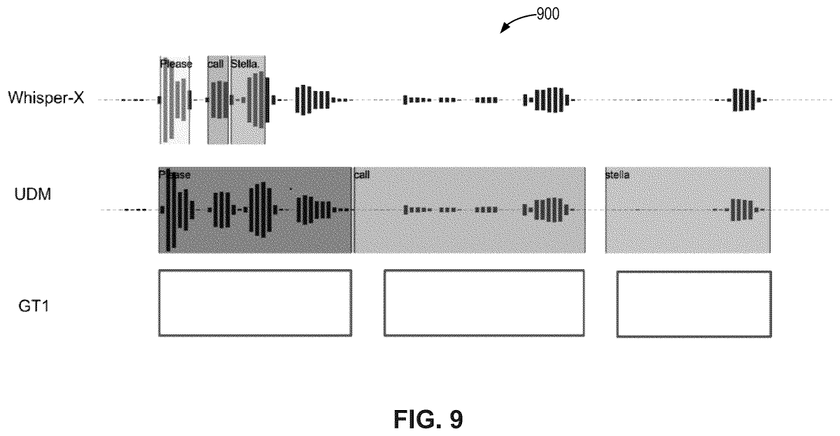

Results from Whisper and zero-order text refresher are presented. In these settings, recursive word transcription modeling can be conducted in multiple orders. The recursive process involves the following steps: The default UDM provides zero-order results. After the initial smoothed segmentation, a 2D alignment search is performed and further smoothed segmentation at the segment level. This yields 1st-order word segmentation and 1st-order word transcription. Additionally, the 1st-order 2D-Alignment can be used to guide the text refresher, which also provides 1st-order word transcription. The better of the two can be selected as the final 1st-order transcription, which can be used as the final predictions. By repeating this process, 2nd-order word transcriptions, 3rd-order word transcriptions, and so on can be obtained. For word segmentation evaluation, WhisperX can be utilized, which provides timing information for each word. The results are detailed in Table 2 below for word transcription evaluation and Table 3 below for word segmentation evaluation. Disfluent speech segmentation results are illustrated by FIGS. 5-9.

TABLE 2
Word Transcription Evaluation

| | (WER %, †) | | | |
|---|---|---|---|---|
| URFA Config | Zero-order | 1st-order | 2nd-order | 3rd-order |
| Whisper-Large | 11.3 | — | — | — |
| +Text Refresher | 9.7 | 9.4 | 9.2 | 9.2 |
| +VCTK⁺⁺ | 9.2 | 9.0 | 8.7 | 8.7 |
| +CTC | 8.8 | 8.6 | 8.4 | 8.4 |

TABLE 3
Word Segmentation Evaluation

| | MS(%, †) | | | |
|---|---|---|---|---|
| URFA Config | Zero-order | 1st-order | 2nd-order | 3rd-order |
| Whisper-X | 42.1 | — | — | — |
| Ours | 77.4 | 79.4 | 81.2 | 81.4 |

### Disfluency Detection

UFA-VCTK and UFA-VCTK++ can be selected as the default phoneme transcriber, as they exhibit the best phonetic transcription performance, as demonstrated in Table 1. It should be noted that the representations used for disfluency detection are always based on the 2D-Alignment, but with different orders of computations, including 1st-order, 2nd-order, and 3rd-order. The results are presented in Tables 4 and 5 below. MS refers to the “Matching Score.”

TABLE 4
Phonetic disfluency Detection Evaluation

| URFA | F1 | MS | Human | Human |
|---|---|---|---|---|
| Settings | (%, †) | (%, †) | PT (%, †) | MS (%, †) |
| UFA-VCTK | 62.4 | 55.2 | 90.4 | 85.6 |
| UFA-VCTK⁺⁺ | 64.5 | 60.2 | 90.6 | 86.0 |
| +CTC | 65.0 | 60.4 | 90.5 | 86.2 |
| +1st-order | 65.6 | 61.0 | 90.6 | 86.0 |
| +2nd-order | 67.0 | 62.7 | 90.6 | 86.0 |
| +3rd-order | 67.2 | 62.8 | 90.7 | 86.2 |

TABLE 5
Word disfluency Detection Evaluation

| Methods | F1 (%, †) | Human F1 (%, †) |
|---|---|---|
| Whisper-Large | 64.0 | 86.4 |
| +Text Refresher(VCTK) | 66.8 | 88.0 |
| +Text Refresher(VCTK⁺⁺) | 68.4 | 89.1 |
| +CTC | 68.8 | 89.2 |
| +1st-order | 70.1 | 89.1 |
| +2nd-order | 73.0 | 89.3 |
| +3rd-order | 73.1 | 80.3 |

### Results

### Transcription Analysis

In the phonetic results presented in Table 1 above, UFA with VCTK/VCTK++ consistently outperforms the other baseline settings. Therefore, only monotonicity (CTC) is introduced to UFA+VCTK/VCTK++. Ultimately, the inclusion of CTC significantly enhances performance across all metrics. Regarding word transcription results, as shown in Table 2 above, two aspects are observed. First, when examining the default setting, which corresponds to the zero-order setting, it can be seen that CTC improves zero-order transcription results. Second, when further exploring recursive inference experiments, the results for the (n+1)th order are consistently better than those for the nth order. It should be noted that CTC, which introduces monotonicity, further boosts performance. In FIG. 2, after the 1st-order URFA iteration, the detection of disfluent word boundaries surpasses that achieved in the zero-order iteration. This conclusion also holds true for disfluent word segmentation results, as reported in Table 3. Notably, the disclosed methods outperform others by a significant margin. Furthermore, more examples are provided by FIGS. 5-9 to illustrate its effectiveness.

### Disfluency Analysis

Examined herein are both phonetic-level and word-level dysfluencies in Tables 4 and 5, respectively. It is evident that the introduction of CTC monotonicity consistently enhances performance at both levels. Additionally, when considering recursive modeling, progressively improved performance can be observed as the number of orders is increased.

### EXAMPLES

In an example, a method for processing audio inputs to detect and transcribe disfluencies includes: receiving an audio input comprising spoken language; generating a phonetic transcription of the audio input by applying a recursive forced alignment process that produces a two-dimensional alignment without reliance on a monotonic alignment constraint; identifying disfluencies within the audio input by comparing a pre-determined number of disfluency templates to the two-dimensional alignment; providing a timestamp for each detected disfluency; and outputting a transcription of the audio input that includes indications of the detected disfluencies and their respective timestamps.

In certain embodiments, the recursive forced alignment process includes an iterative re-segmentation based on word boundaries derived from the two-dimensional alignment to refine the phonetic transcription.

In certain embodiments, the pre-determined number of disfluency templates are configured to detect various types of disfluencies including repetitions, replacements, insertions, deletions, and irregular pauses.

In certain embodiments, the recursive forced alignment process further includes: applying a conformer module to predict alignment and boundary information from the latent representations.

In certain embodiments, identifying disfluencies within the audio input further comprises employing a text refresher module that utilizes the two-dimensional alignment to detect word-level disfluencies by comparing the phonetic transcription against a reference text.

In certain embodiments, the text refresher module identifies insertions and deletions based on discrepancies between the phonetic transcription and the reference text.

Certain embodiments further include generating an imperfect word transcription of the audio input using insertions and deletions identified in the two-dimensional alignment.

In certain embodiments, the imperfect word transcription is evaluated using an imperfect word error rate and a Matching Score based on an Intersection over Union between predicted time boundaries and ground truth annotations.

In certain embodiments, the transcription of the audio input is further refined to generate a hierarchical representation of disfluencies, the hierarchical representation comprising: identifying disfluencies at both the word-level and phoneme-level within the audio input.

In certain embodiments, the hierarchical representation further comprises associating each identified disfluency with a corresponding timestamp indicative of occurrence of the disfluency within the audio input.

In certain embodiments, the hierarchical representation further comprises outputting a structured transcription that includes the hierarchical representation of disfluencies, wherein the structured transcription delineates word-level disfluencies from phoneme-level disfluencies and provides temporal localization for each.

In certain embodiments, the two-dimensional alignment comprises represents temporal correspondence between actual spoken text by a speaker and a disfluent alignment generated.

In certain embodiments, the two-dimensional alignment is computed by performing element-wise multiplication between reference phoneme embeddings and forced alignment phoneme embeddings.

In certain embodiments, the two-dimensional alignment comprises a first dimension corresponding to a sequence of phonemes in the spoken language in the audio input and a second dimension corresponding to a sequence of phonemes in a reference text.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGAs, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention.

1. A computer-implemented method for processing audio inputs to detect and transcribe disfluencies, the computer-implemented method comprising:
receiving an audio input comprising spoken language;
generating a phonetic transcription of the audio input by applying a recursive forced alignment process that produces a two-dimensional alignment without reliance on a monotonic alignment constraint;
identifying disfluencies within the audio input by comparing a pre-determined number of disfluency templates to the two-dimensional alignment;
providing a timestamp for each detected disfluency; and
outputting a transcription of the audio input that includes indications of the detected disfluencies and their respective timestamps.

2. The computer-implemented method of claim 1, wherein the recursive forced alignment process includes an iterative re-segmentation based on word boundaries derived from the two-dimensional alignment to refine the phonetic transcription.

3. The computer-implemented method of claim 1, wherein the pre-determined number of disfluency templates are configured to detect various types of disfluencies including repetitions, replacements, insertions, deletions, and irregular pauses.

4. The computer-implemented method of claim 1, wherein the recursive forced alignment process comprises:
encoding the audio input to generate latent representations.

5. The computer-implemented method of claim 4, wherein the recursive forced alignment process further comprises:
applying a conformer module to predict alignment and boundary information from the latent representations.

6. The computer-implemented method of claim 1, wherein identifying disfluencies within the audio input further comprises employing a text refresher module that utilizes the two-dimensional alignment to detect word-level disfluencies by comparing the phonetic transcription against a reference text.

7. The computer-implemented method of claim 6, wherein the text refresher module identifies insertions and deletions based on discrepancies between the phonetic transcription and the reference text.

8. The computer-implemented method of claim 1, wherein the method further comprises:
generating an imperfect word transcription of the audio input using insertions and deletions identified in the two-dimensional alignment.

9. The computer-implemented method of claim 8, wherein the imperfect word transcription is evaluated using an imperfect word error rate and a Matching Score (MS) based on an Intersection over Union between predicted time boundaries and ground truth annotations.

10. The computer-implemented method of claim 1, wherein the transcription of the audio input is further refined to generate a hierarchical representation of disfluencies, the hierarchical representation comprising:
identifying disfluencies at both the word-level and phoneme-level within the audio input.

11. The computer-implemented method of claim 10, the hierarchical representation further comprising:
associating each identified disfluency with a corresponding timestamp indicative of occurrence of the disfluency within the audio input.

12. The computer-implemented method of claim 11, the hierarchical representation further comprising:
outputting a structured transcription that includes the hierarchical representation of disfluencies.

13. The computer-implemented method of claim 12, wherein the structured transcription delineates word-level disfluencies from phoneme-level disfluencies and provides temporal localization for each.

14. The computer-implemented method of claim 1, wherein the two-dimensional alignment comprises represents temporal correspondence between actual spoken text by a speaker and a disfluent alignment generated.

15. The computer-implemented method of claim 14, wherein the two-dimensional alignment is computed by performing element-wise multiplication between reference phoneme embeddings and forced alignment phoneme embeddings.

16. The computer-implemented method of claim 1, wherein the two-dimensional alignment comprises a first dimension corresponding to a sequence of phonemes in the spoken language in the audio input and a second dimension corresponding to a sequence of phonemes in a reference text.

17. One or more non-transitory computer-readable media storing instructions that, when executed by one or more processors, cause the one or more processors to perform the computer-implemented method of claim 1.
